(19) United States
(12) Patent Application Publication
(10) Pub. No.: US 2025/0342011 A1
(43) Pub. Date: Nov. 6, 2025

(54) SYSTEMS AND METHODS FOR STANDARDIZING DEFINITION OF SOFTWARE ARCHITECTURES

(71) Applicant: Facets Cloud Inc., Lewes, DE (US)

(72) Inventors: Anshul SAO, Bangalore (IN); Pravanjan CHOUDHURY, Bangalore (IN); Rohit RAVEENDRAN, Bangalore (IN)

(21) Appl. No.: 18/817,538

(22) Filed: Aug. 28, 2024

(30) Foreign Application Priority Data
May 6, 2024 (IN) 202441035959

(51) Int. Cl. G06F 8/20

(52) U.S. Cl. CPC G06F 8/20

(57) ABSTRACT

A system for standardizing the definition of a software architecture is provided. The system includes a customizable domain specific language (DSL) configured to define a structure and one or more architectural components of the software architecture and a catalogue having one or more resources that are customizable based on the defined structure of the software architecture. The system further includes a web interface communicatively coupled to an interpreter. The web interface is configured to translate the domain specific language (DSL) to a visual representation and enable creation of standardized visual representations of the software architecture. Each visual representation includes one or more resources of the catalogue arranged in accordance with the structure of the software architecture.

### CROSS REFERENCE TO RELATED APPLICATION

This application claims a benefit of, and priority to, India Provisional Patent Application No. 202441035959, filed May 6, 2024, the content of which is incorporated by reference in its entirety.

### BACKGROUND

Embodiments of the present invention relate generally to software architecture blueprints, and more particularly to methods and systems for standardizing definition of software architectures.

In software development, architecture is a key blueprint outlining a system's structure and behavior including definition of its components, their relationships, and governing rules. The absence of a universally accepted definition language for these architectures leads to challenges like collaboration difficulties, inconsistency, limited reusability, inefficient communication, and visualization issues. The lack of standardization can thereby result in delays in completion of software projects. Adopting a standardized language could facilitate automated reviews, enforce standards, validate policies, and enable direct environment provisioning from software architectures, that would in turn streamline software development processes.

Hence there is a need for a method and system that can standardize the definition of software architectures in order to adapt to the varying requirements of software projects. Accordingly, an alternate method and system for standardizing software architectures is proposed.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for standardizing the definition of a software architecture is provided. The system includes a customizable domain specific language (DSL) configured to define a structure and one or more architectural components of the software architecture and a catalogue having one or more resources that are customizable based on the defined structure of the software architecture. The system further includes a web interface communicatively coupled to an interpreter. The web interface is configured to translate the domain specific language (DSL) to a visual representation and enable creation of standardized visual representations of the software architecture. Each visual representation includes one or more resources of the catalogue arranged in accordance with the structure of the software architecture.

In another embodiment, a method for standardizing the definition of a software architecture is provided. The method includes defining a structure of the software architecture and one or more architectural components required for the software architecture using a customizable domain specific language (DSL) and collating one or more resources using the DSL into a catalogue to define the software architecture. The one or more resources comprise the one or more architectural components, each of the architectural components being customizable based on the defined structure of the software architecture. The method also includes standardizing definitions of the architectural components across a plurality of users, configuring one or more implementations of the architectural components and facilitating creation of standardized visual representations of the software architecture. Each visual representation includes one or more resources of the catalogue arranged in accordance with the structure of the software architecture.

In another embodiment, a system for standardizing the definition of a software architecture is provided. The system includes a memory storing one or more processor-executable routines and a processor communicatively coupled to the memory. The processor is configured to execute the one or more processor-executable routines to define a structure and one or more architectural components of the software architecture using a customizable domain specific language (DSL) and collate one or more resources using the DSL into a catalogue to define the software architecture. The one or more resources are customizable based on the defined structure of the software architecture. The processor is further configured to translate the domain specific language (DSL) to a visual representation to create standardized visual representations of the software architecture. Each visual representation includes one or more resources of the catalogue arranged in accordance with the structure of the software architecture.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is an example environment illustrating components for standardizing definition of software architectures, according to some aspects of the present description;

FIG. 2 is an example of a system for standardizing the definition of a software architecture, according to some aspects of the present description;

FIG. 3 illustrates an example user interface of the example system of FIG. 2, according to some aspects of the present description;

FIG. 4 is a flowchart depicting a method for standardizing the definition of software architecture, according to some aspects of the present description; and

FIG. 5 is a block diagram illustrating an example computer system, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present description provide systems and methods for standardizing the definition of software architectures. The disclosed system has the capabilities of software architecture definition along with integrated visualization and collaboration capabilities.

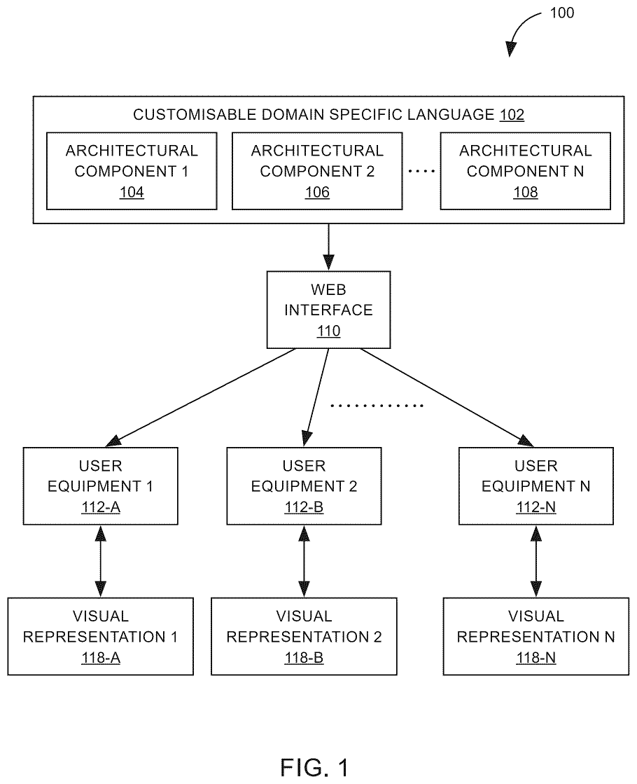

FIG. 1 illustrates an example environment 100 illustrating components for standardizing definition of software architectures, according to some aspects of the present description. The environment 100 includes a customizable domain specific language (CDSL) 102, a web interface 110, and a plurality of user equipment generally represented by reference numerals 112a-112n.

The CDSL 102 is configured to define a structure of a software architecture. The definition of the structure of the software architecture may include one or more architectural components such as represented by reference numerals 104, 106 and 108. The CDSL 102 enables a user to define the one or more architectural components 104, 106 and 108, and specify one implementation from a plurality of available implementations for the each architectural component (e.g. 104). The CDSL 102 is further configured to provide a reference to one or more resource attributes of the each architectural component 104.

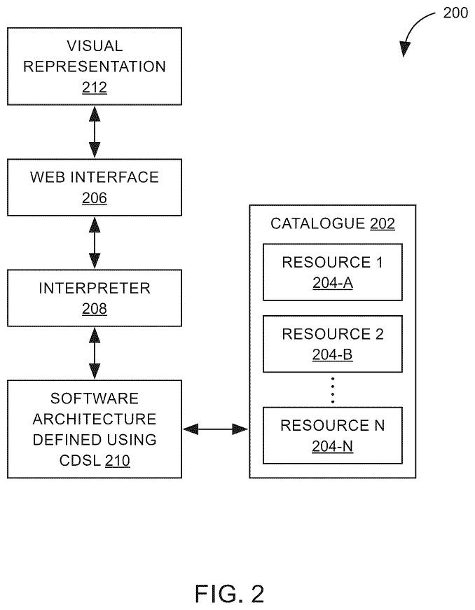

The CDSL 102 is coupled to a web interface 110, and the web interface 110 is coupled to the one or more user equipment generally represented by reference numerals 112a-112n. In this example, the software blueprint created within the CDSL 102, is rendered on the each user equipment (e.g. 112a) as a visual representation (118a). Similarly, a version of the software architecture is rendered on the user equipment 112b as visual representation 114b, and on user equipment 112c as visual representation 114c. The system for standardizing software architectures is further explained with respect to FIG. 2.

FIG. 2 illustrates a system 200 for standardizing definition of software architectures. The system 200 includes, a structure of software architecture 210 defined using CDSL, a catalogue 202, a web interface 206, an interpreter 208, a visual representation 212. In an embodiment, the catalogue 202 includes one or more resources such as represented by reference numerals 204a-204n. The visual representation 212 includes a representation of the one or more resources as 214a-214n. In an embodiment, the one or more resources 204a-204n includes architectural components, services, databases and caches, or combinations thereof.

In an embodiment, the CDSL 214 typically defines the structure of the software architecture 210. The CDSL 214, enables a user to define the one or more resources 204a-204n of the catalogue 202. Further the CDSL 214 specifies one implementation from a plurality of available implementations for the each resource 204a-204n or of the each architectural component. The CDSL 214 references one or more resource attributes of the each architectural component or of the each resource 204a-204n.

Further, the catalogue 202 is neutral of a type and configuration of a cloud on which the catalogue 202 and the software architecture is hosted. For example, the catalogue may store resources from various software architectures.

The web interface 206 is communicatively coupled to the interpreter 208, and is configured to translate a domain specific language (DSL) to the visual representation 212. Further, the web interface 206 enables creation of standardized visual representations of the software architecture. In an embodiment, each visual representation 212 includes one or more resources of the catalogue 202 arranged in accordance with the structure of the software architecture.

In one example, the web interface 206 is configured to share the one or more architectural designs of the structure across a plurality of users of the system 100. Further, the web interface 206 is configured to facilitate standardization of definitions of each architectural component for use across a plurality of users of the system 100.

In addition, the web interface 206 is configured to share the one or more architectural designs of the structure to a reference architecture repository (not shown) accessible to the plurality of users. The web interface 206 is further configured to enable users to inherit architectural designs from the reference architecture repository and mutate the inherited architectural designs based upon a selected implementation to create one or more mutated architectural designs and share the one or more mutated architectural designs to the reference architecture repository for use by the plurality of users.

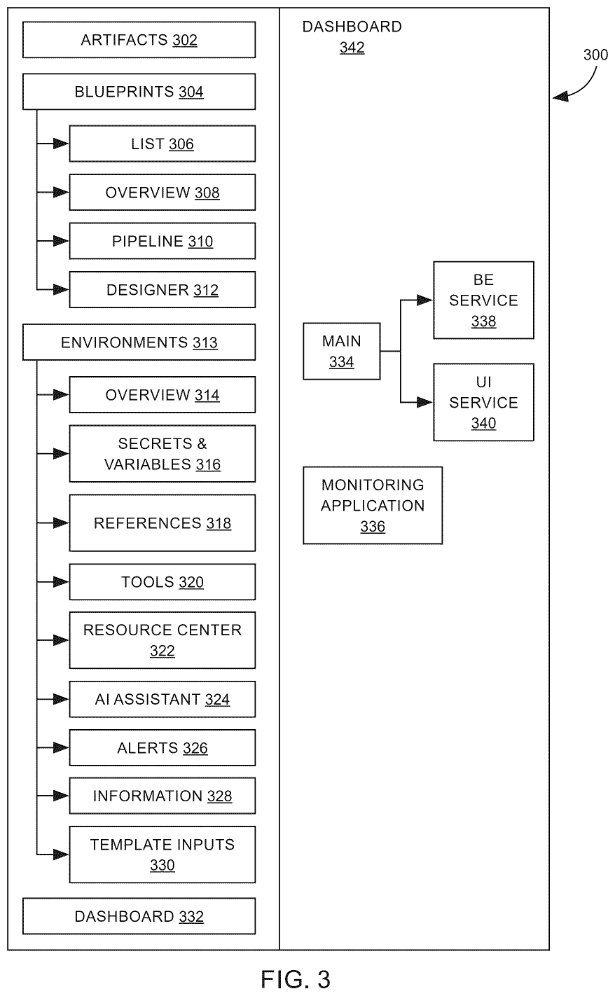

A user interface in which the functioning of the system of FIG. 2 can be explained is illustrated in FIG. 3.

FIG. 3 illustrates an example user interface 300 on which software architecture blueprints are standardized, according to some aspects of the present description. The user interface 300, includes artifacts 302, blueprints 304, list 306, overview 308, pipeline 310, and designer 312. Further, multiple environments 313 are provided. Each environment may include an overview 314, secrets and variable 316, references 318, tools 320, resource center 322, and Artificial Intelligence (AI) assistant 324, alerts 326, information 328, template inputs 330, and a dashboard 332.

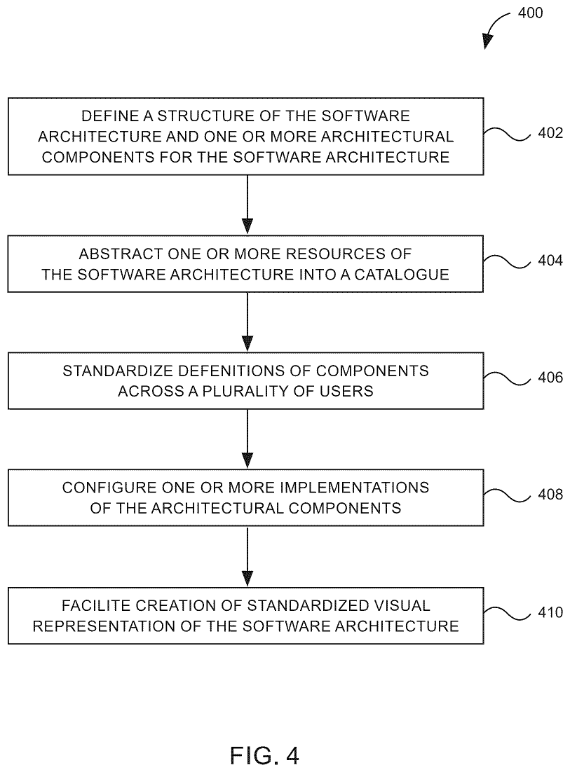

In an example of developing a standardized architecture, within a dashboard 342, a module like main 334, and a monitoring application such as Prometheus 336 is employed. The module main 334 can further communicate to a BE service 338 and UI (user interface) service 310. A method of standardizing the definition of a software architecture is illustrated in an example process 400 of FIG. 4.

At 402, a structure of the software architecture and one or more architectural components required for the software architecture using a customizable domain specific language (CDSL) is defined.

At 404, one or more resources of the software architecture are collated using the CDSL into a catalogue. The one or more resources include one or more architectural components that are customizable based on the defined structure of the software architecture. In an embodiment, a plurality of components of the software architecture is abstracted into a cloud-neutral catalogue.

At 406, definitions of components across a plurality of users are standardized. Further at block 408, one or more implementations of the architectural components are configured. In an embodiment, the one or more resources can be modified by the CDSL based on a requirement of the architecture. Also, a plurality of implementations of the each architectural component is specified based on a requirement. Further, a switch between a plurality of implementations of the software architecture is facilitated, where each implementation is based on the requirement of the architecture, and wherein the one or more resources are adapted to the each implementation.

At 410, creation of standardized visual representations of the software architecture is facilitated where each visual representation comprises one or more resources of the catalogue arranged in accordance with the structure of the software architecture. In an embodiment, one or more architectural designs of the structure are shared across a plurality of users, and the definitions of the each architectural component is standardized for use across the plurality of users. The CDSL is further configured to reference one or more resource attributes of the each architectural component.

As disclosed above, the disclosed system and method utilizes CDSL to provide a flexible framework for defining architectural components. It not only enables architects to detail the structure of a software system, but also allows the architects to define types of components. For example, an architect can create a component that focuses purely on the architectural aspects. Further, the CDSL enables a user to reference resource attributes in other attributes and specify multiple implementations retaining same specification. Further, resource types can be user-defined.

The CDSL employed in the system enables easy sharing and collaboration on architectural designs across different teams, eliminating the complexity associated with understanding unique notations used by different teams. The CDSL ensures consistency in architecture design across different projects or within large-scale projects. By providing a standardized framework, potential errors and inefficiencies that arise from the absence of a uniform language are reduced. The CDSL is hosted on a user-friendly web interface, that makes architectural designs easily understandable. This enhances the reusability of the software architectures, as different teams can comprehend and adopt the designs more readily due to the standardized language.

Further, the present disclosure addresses the problem of ineffective communication by using the CDSL to represent architectural concepts. This mitigates confusion arising from the use of varied terminologies and notations, leading to improved communication among teams. The web interface of the invention comes equipped with an interpreter that translates the CDSL into a visual representation. This makes it easier to create universally understandable visual representations of architectures, overcoming the challenges presented without a standard definition language.

The web interface also designs architecture as an integral part of the application and provides a platform for visualizing and visually mutating software architectures. The disclosed system provides a platform for visualizing and visually mutating software architectures. Further, the system provides a canvas to add resources, that can be modified visually by opening up an underlying definition in DSL. Further, the web interface displays resources and their relationship with other resources.

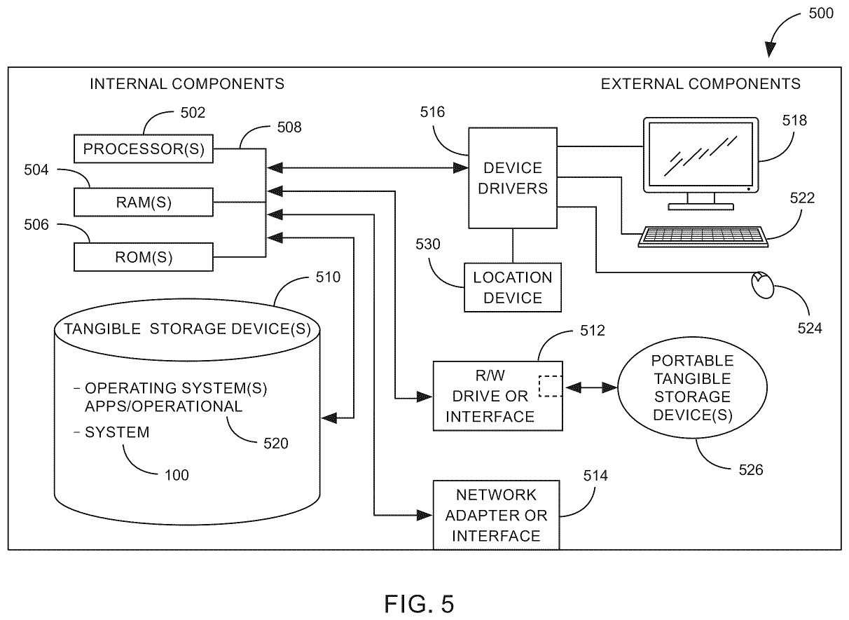

The modules of the system (100) for standardizing software architectures, described herein are implemented in computing devices. One example of a computing device (500) is described below in FIG. 5. The computing device (500) includes one or more processor(s) (502), one or more computer-readable RAMs (504) and one or more computer-readable ROMs (506) on one or more buses (508). Further, computing device (500) includes a tangible storage device (510) that may be used to execute operating systems (520) and the system (100) for standardizing definition of software architecture. The various modules of the system (500) may be stored in the tangible storage device (510). Both, the operating systems (520) and the system (100) are executed by the one or more processor(s) (502) via one or more respective RAMs (504) (which typically include cache memory). The execution of the operating systems (520) and/or the system (200) by the one or more processor(s) (502), configures the one or more processor(s) (502) as a special purpose processor configured to carry out the functionalities of the operation systems (520) and/or the system (100) as described above.

Examples of the tangible storage device (510) include semiconductor storage devices such as ROM, EPROM, flash memory or any other computer-readable tangible storage device that may store a computer program and digital information.

Computing device (500) also includes a R/W drive or interface (514) to read from and write to one or more portable computer-readable tangible storage devices (528) such as a CD-ROM, DVD, memory stick or semiconductor storage device. Further, network adapters or interfaces (512) such as a TCP/IP adapter cards, wireless Wi-Fi interface cards, or 3G or 4G wireless interface cards or other wired or wireless communication links are also included in computing device.

In one example embodiment, the system (200) may be stored in the tangible storage device (510) and may be downloaded from an external computer via a network (for example, the Internet, a local area network or other, wide area network) and network adapter or interface (512).

Computing device (500) further includes device drivers (516) to interface with input and output devices. The input and output devices may include a computer display monitor (518), a keyboard (522), a keypad, a touch screen, a computer mouse (524), and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

What is claimed is:

1. A system for standardizing the definition of a software architecture, wherein the system comprises:
a customizable domain specific language (DSL) configured to define a structure and one or more architectural components of the software architecture;
a catalogue having one or more resources that are customizable based on the defined structure of the software architecture; and
a web interface communicatively coupled to an interpreter and configured to:
translate the domain specific language (DSL) to a visual representation; and
enable creation of standardized visual representations of the software architecture, wherein each visual representation comprises one or more resources of the catalogue arranged in accordance with the structure of the software architecture.

2. The system of claim 1, wherein the one or more resources comprise of architectural components, services, databases, caches, or combinations thereof.

3. The system of claim 2, wherein the customizable DSL is further configured to:
receive inputs from a user to define the one or more architectural components; and
specify one implementation from a plurality of available implementations for the each architectural component.

4. The system of claim 3, wherein the customizable DSL is further configured to reference one or more resource attributes of the each architectural component.

5. The system of claim 1, wherein the catalogue is neutral of a type and configuration of a cloud on which the catalogue and the software architecture is hosted.

6. The system of claim 1, wherein the web interface is configured to share the one or more architectural designs of the structure across a plurality of users.

7. The system of claim 6, wherein the web interface is further configured to facilitate standardization of definitions of each architectural component for use across the plurality of users.

8. The system of claim 6, wherein the web interface is configured to share the one or more architectural designs to a reference architecture repository accessible to the plurality of users.

9. The system of claim 8, wherein the web interface is further configured to:
enable users to inherit architectural designs from the reference architecture repository;
mutate the inherited architectural designs based upon a selected implementation to create one or more mutated architectural designs; and
share the one or more mutated architectural designs to the reference architecture repository for use by the plurality of users.

10. A method for standardizing the definition of a software architecture, the method comprising:
defining a structure of the software architecture and one or more architectural components required for the software architecture using a customizable domain specific language (DSL);
collating one or more resources using the DSL into a catalogue to define the software architecture, wherein the one or more resources comprise the one or more architectural components, each of the architectural components being customizable based on the defined structure of the software architecture;
standardizing definitions of the architectural components across a plurality of users;
configuring one or more implementations of the architectural components; and
facilitating creation of standardized visual representations of the software architecture, wherein each visual representation comprises one or more resources of the catalogue arranged in accordance with the structure of the software architecture.

11. The method of claim 10, further comprising abstracting a plurality of components of the software architecture into a cloud-neutral catalogue.

12. The method of claim 10, further comprising:
modifying, using the customizable DSL, one or more resources of the catalogue based upon a requirement of the architecture;
specifying a plurality of implementations of the each architectural component based on the requirement; and
facilitating a switch between a plurality of implementations of the software architecture, wherein each implementation is based on the requirement of the architecture, and wherein the one or more resources are adapted to the corresponding implementation.

13. The method of claim 10, further comprising:
facilitating sharing one or more architectural designs of the structure across a plurality of users; and
standardizing definitions of each architectural component for use across the plurality of users.

14. The method of claim 10, further comprising referencing one or more resource attributes of the each architectural component using the customizable DSL.

15. A system for standardizing the definition of a software architecture, the system comprising:
a memory storing one or more processor-executable routines; and
a processor communicatively coupled to the memory, the processor configured to execute the one or more processor-executable routines to:
define a structure and one or more architectural components of the software architecture using a customizable domain specific language (DSL);
collate one or more resources using the DSL into a catalogue to define the software architecture, wherein the one or more resources are customizable based on the defined structure of the software architecture; and
translate the domain specific language (DSL) to a visual representation to create standardized visual representations of the software architecture, wherein each visual representation comprises one or more resources of the catalogue arranged in accordance with the structure of the software architecture.

16. The system of claim 15, wherein the system comprises a web interface and an interpreter configured to generate the standardized visual representations of the software architecture.

17. The system of claim 15, wherein the web interface is configured to share one or more architectural designs of the structure across a plurality of users and store the designs on a reference architecture repository.

18. The system of claim 17, wherein the web interface is further configured to:
enable users to inherit architectural designs from the reference architecture repository;
mutate the inherited architectural designs based upon a selected implementation to create one or more mutated architectural designs; and
share the one or more mutated architectural designs to the reference architecture repository for use by the plurality of users.

19. The system of claim 15, wherein the one or more resources comprise architectural components, services, databases, caches, or combinations thereof.

20. The system of claim 15, wherein the processor is further configured to:
receive inputs from the users to define the one or more architectural components; and
specify one implementation from a plurality of available implementations for the each architectural component using the DSL.
